(19) United States
(12) Patent Application Publication
(10) Pub. No.: US 2024/0111549 A1
(43) Pub. Date: Apr. 4, 2024

(54) METHOD AND APPARATUS FOR CONSTRUCTING ANDROID RUNNING ENVIRONMENT

(71) Applicant: Beijing Bytedance Network Technology Co., Ltd., Beijing (CN)

(72) Inventor: Chengcheng LIU, Beijing (CN)

(21) Appl. No.: 18/554,380

(22) PCT Filed: Mar. 30, 2022
(86) PCT No.: PCT/CN2022/083883

§ 371 Date: Oct. 6, 2023

(30) Foreign Application Priority Data
Apr. 7, 2021 (CN) 202110376316.0

(51) Int. Cl. G06F 9/445; G06F 9/4401

(52) U.S. Cl. CPC G06F 9/44505; G06F 9/4406

(57) ABSTRACT

Disclosed in the present application are a method and apparatus for constructing an Android running environment. The method in the present application includes: when a Linux service needs to start an Android service, the Linux service initiating a creation request for an Android environment seed process by means of an inter-process communication (IPC) interface, wherein the creation request includes a path and a running parameter of a program corresponding to the Android service that needs to be started; and after receiving the creation request, the Android environment seed process running the Android service in the manner of deriving a fork process.

### CROSS-REFERENCE TO RELATED APPLICATIONS

This application is based on and claims the benefit of priority to the Chinese patent application No. 202110376316.0 filed on Apr. 9, 2021, which is hereby incorporated by reference in its entirety into the present application.

### TECHNICAL FIELD

The application relates to the field of operating systems, and in particular to a method and a device of building an Android running environment.

### BACKGROUND

When an operating system of a terminal is developed based on a Linux system, most libraries of current chip developers and driving developers are closed-source libraries developed based on Android, and therefore, an Android running environment needs to be built on the Linux system with the aid of an Android Hardware Abstraction Layer (HAL) library. At present, in the related art, the Android running environment based on the Linux system is usually implemented with the aid of a container open source tool such as an LXC Container (Linux Container).

### SUMMARY

According to a first aspect of the present application, there is provided a method of building an Android running environment.

The method of building an Android running environment according to the present application comprises: when a Linux service needs to start an Android service, initiating, by the Linux service, a creation request to an Android environment seed process via an IPC (Inter-Process Communication) interface, the creation request at least comprising a path and a running parameter of a program corresponding to the Android service that needs to be started; running, after the Android environment seed process received the creation request, the Android service by a fork process.

In some embodiments, the method further comprises creating the Android environment seed process on the Linux system according to the following steps of: separating a file system of the Android environment seed process from at least one Linux file system; mounting an Android file system required for running an Android program, and uninstalling a Linux file system of the at least one Linux file system which conflicts with the Android file system; creating a basic service process or thread required for running the Android program.

In some embodiments, the method further comprises: judging whether to switch a root directory of the Android file system or not according to different application scenes.

In some embodiments, the mounting an Android file system required for running an Android program comprises: at least mounting a file system of a third-party class library extension directory vendor and a file system of a Vendor Native Development Kit (VNDK) required for running an Android hardware abstraction layer (Android HAL).

In some embodiments, the creating a basic service process or thread required for running the Android program comprises: at least creating a property service and a service manager (ServiceManager) service.

In some embodiments, the separating a file system of the Android environment seed process from at least one Linux file system comprises: separating the file system of the Android environment seed process from a Linux file system of the at least one Linux file system according to a file path.

In some embodiments, the mounting an Android file system required for running an Android program comprises: mounting the Android file system corresponding to the application scene according to an actual application scene.

In some embodiments, the creating a basic service process or thread required for running the Android program comprises: creating a new thread corresponding to the basic service or forking a new process.

According to a second aspect of the application, there is provided another device of building an Android running environment.

The device of building an Android running environment according to the present application comprises: a request initiating module for, when a Linux service needs to start an Android service, initiating, by the Linux service, a creation request to an Android environment seed process via an IPC interface, the creation request at least comprising a path and a running parameter of a program corresponding to the Android service that needs to be started; a running module for running, after the Android environment seed process received the creation request, the Android service by a fork process.

In some embodiments, the device further comprises: a seed process creating module for creating the Android environment seed process on the Linux system according to the following steps of:
separating a file system of the Android environment seed process from at least one Linux file system; mounting an Android file system required for running an Android program, and uninstalling a Linux file system of the at least one Linux file system which conflicts with the Android file system; creating a basic service process or thread required for running the Android program.

In some embodiments, the separating a file system of the Android environment seed process from at least one Linux file system comprises: separating the file system of the Android environment seed process from the at least one Linux file system according to a file path.

In some embodiments, the mounting an Android file system required for running an Android program comprises: mounting the Android file system corresponding to the application scene according to an actual application scene.

In some embodiments, the creating a basic service process or thread required for running the Android program comprises: creating a new thread corresponding to the basic service or forking a new process.

In some embodiments, the seed process creating module is further used for judging whether to switch a root directory of the Android file system or not according to different application scenes.

In some embodiments, the seed process creating module is further used for: at least mounting a file system of a third-party class library extension directory vendor and a file system of a Vendor Native Development Kit (VNDK) required for running an Android hardware abstraction layer (Android HAL).

In some embodiments, the seed process creating module is further used for: at least creating a property service and a service manager (ServiceManager) service.

According to a third aspect of the present application, there is provided a non-transitory computer-readable storage medium storing computer instructions for causing the computer to perform the method of building an Android running environment according to any item of the above first aspect.

According to a fourth aspect of the present application, there is provided an electronic apparatus comprising: at least one processor; and a memory communicatively connected to the at least one processor; wherein the memory stores a computer program executable by the at least one processor, the computer program being executable by the at least one processor to cause the at least one processor to perform the method of building an Android running environment according to any item of the above first aspect.

According to a fifth aspect of the present application, there is provided a computer program comprising: instructions which, when executed by a processor, cause the processor to perform the method of building an Android running environment according to any one of the above embodiments.

According to a sixth aspect of the present application, there is provided a computer program product comprising instructions which, when executed by a processor, cause the processor to perform the method of building an Android running environment according to any one of the above embodiments.

### BRIEF DESCRIPTION OF THE DRAWINGS

The accompanying drawings, which are incorporated in and constitute a part of this application, are comprised to provide a further understanding of the application and to enable other features, objects, and advantages of the application to be more apparent. The drawings and the description of the exemplary embodiments of the present application are provided for explaining the present application and do not constitute an undue limitation on the present application. In the drawings:

FIG. 1 is a flow chart of a method of building an Android running environment according to some embodiments of the present application;

FIG. 2 is another flow chart of building an Android running environment according to some embodiments of the present application;

FIG. 3 is a component block diagram of a device of building an Android running environment according to some embodiments of the present application.

### DETAILED DESCRIPTION

In order to make the technical solutions of the present application better understood by those skilled in the art, the technical solutions in the embodiments of the present application will be clearly and completely described below with reference to the drawings in the embodiments of the present application, and it is obvious that the described embodiments are only some embodiments of the present application, and not all embodiments. All other embodiments obtained by a person of ordinary skill in the art based on the embodiments in the present application without making any creative effort shall fall within the protection scope of the present application.

It should be noted that the terms “first”, “second” and the like in the description and claims of this application and in the accompanying drawings are used for distinguishing between similar elements and not necessarily for describing a particular sequential or chronological order. It should be understood that the data soused may be interchanged under appropriate circumstances in order to facilitate the description of the embodiments of the application herein. Moreover, the terms “comprising” and “having” and any variations thereof, are intended to cover a non-exclusive inclusion, such that a process, method, system, article, or apparatus that comprises a list of steps or elements is not necessarily limited to those steps or elements expressly listed, but may comprise other steps or elements not expressly listed or inherent to such process, method, article, or apparatus.

It should be noted that, in the present application, the embodiments and features of the embodiments may be combined with each other without conflict. The present application will be described in detail below with reference to the accompanying drawings in conjunction with embodiments.

The inventor finds that, when a method in the related art is applied, the method of building the Android running environment by the LXC or other container tool in the related art has the following disadvantages.

The manufacture of a container by the LXC or other tool is designed for the whole Android system. When the Android running environment is built, the whole Android system is placed into the container. The system is relatively bloated by design, and the control cannot be performed on a single process. In addition, problems of excessive occupation of storage and other resources, long time consumption for starting, and the like, are present.

The present application mainly aims to provide a method and a device of building an Android running environment, and solve the problems of excessive resource consumption, long time consumption and the like present in the building of the Android running environment based on a Linux system in the related art.

In order to achieve the above object, according to some embodiments of the present application, there is provided a method of building an Android running environment. As shown in FIG. 1, the method comprises the following steps.

In S101, when a Linux service needs to start an Android service, the Linux service initiates a creation request to an Android environment seed process via an IPC interface.

The Android environment seed process needs to be created in advance. In some embodiments, the creation process comprises the following steps.

Firstly, a file system of the Android environment seed process is separated from at least one Linux file system.

In some embodiments, the file system of the Android environment seed process is separated from the at least one Linux file system by a Linux unshare (CLONE_NEWNS) method. The separation may be performed according to a file path.

Secondly, an Android file system required for running an Android program is mounted, and a Linux file system which conflicts with the Android file system is unloaded.

In some embodiments, this step is described with an application scene as an Android hardware abstraction layer (Android HAL) as follows: mounting Android file systems required for running the Android hardware abstraction layer (Android HAL), at least comprising a file system of a third-party class library extension directory vendor and a file system of a Vendor Native Development Kit (VNDK). If conflict exists with the file system of the Linux system, the Linux file system which is no longer needed can be unloaded. In addition, it should be noted that, in actual applications, the corresponding file system may be mounted according to an actual application scene, and it is not necessary to mount all the Android file systems.

Finally, a basic service process or thread required for running the Android program is created.

After the mounting of the file system is completed, creation of the most basic Android environment seed process has been completed, but some basic services necessary for running the Android program, such as a property service(PropertyService), a service manager (ServiceManager), and the like, need to be further created. In some embodiments, a new thread corresponding to the basic service is created or a new process is forked. After the creation of the process or thread of the basic service is completed, the building of the final Android running environment is completed. For the case where an application scene is Android HAL, the ServiceManager service may be a HALhwbinder ServiceManager.

After the building of the Android running environment is completed, the Android environment seed process can wait for a creation request of the Android service process.

In some embodiments, when the Linux service needs to start the running of a certain Android service (such as a graphics-related service, etc.), the Linux service initiates a creation request to an Android environment seed Process via an IPC interface, wherein the creation request at least comprises a path and a running parameter of a program corresponding to the Android service that needs to be started. The IPC interface is an inter-process communication interface.

In S102, after the Android environment seed process received the creation request, the Android service is run by a fork process.

Based on the above steps, after the Linux service initiates a creation request to the Android environment seed process via the IPC interface, the Android environment seed process receives the creation request, then creates a process or thread corresponding to the Android service by means of a fork process, and runs an Android program of the Android service corresponding to the creation request. It should be noted that, since the Android running environment of the Android environment seed process has been configured, the Android running environment can be completely inherited by means of fork.

In the embodiments of the present application, the method and the device of building the Android running environment create a lightweight Android running environment on a Linux system, for example, it may be an Android environment seed process. When a Linux service needs to start an Android service, the Linux service initiates a creation request to an Android environment seed process via an IPC interface, and after the Android environment seed process received the creation request, the Android service is run by a fork process. Since the Android running environment of the Android environment seed process has been configured, the Android running environment can be completely inherited by means of fork. The present application is a copy inheritance mechanism of a parent-child process running environment based on a Linux system, and utilizes an environment seed process to fork and run the required Android service process. Compared with the method of building an Android running environment with the aid of a LXC and other container tool in the related art, resources can be greatly saved and the starting speed of the Android service can be improved.

It should be noted that, the Android environment seed process only provides an environment in the present application, and the above LXC and other container tool need to place the whole Android system into one container. Compared with the above container mothed, the lightweight method in the present application reduces required system resources, and can implement the running of the Android service process on demand.

It should be further noted that, in the embodiments of the present application, if the Android file system has been mounted in advance and the Android environment has also been built, only a few simple services and some Android libraries are needed to implement the running of the Android service. When a certain Android service needs to be run, a request is sent to the Android environment seed process, and the Android service can be quickly started. Its performance has no difference from that of the Linux native service.

From the above description, it can be seen that in the method of building an Android running environment according to the embodiments of the present application, a lightweight Android running environment is created on a Linux system, for example, an android environment seed process. When the Linux service needs to start an Android service, the Linux service initiates a creation request to an Android environment seed process via an IPC interface, and after the Android environment seed process received the creation request, the Android service is run by means of a fork process. Since the Android running environment of the Android environment seed process has been configured, the Android running environment can be completely inherited by means of fork. The present application is a copy inheritance mechanism of a parent-child process running environment based on a Linux system, and utilizes an environment seed process to derive fork so as to run the required Android service process. Compared with the mode of building an Android running environment with the aid of a LXC and other container tool in the related art, resources can be greatly saved and the starting speed of the Android service can be improved.

In some embodiments, in addition to the above embodiments, in actual applications, a root directory of the Android file system may be selectively switched according to whether the scene is a lightweight scene or a heavyweight scene. For example, if an application (APP) is about to be started, it belongs to a heavyweight service, and the root directory of the Android file system may be switched, and if some simple services are about to be started, the root directory of the Android file system has no need to be switched.

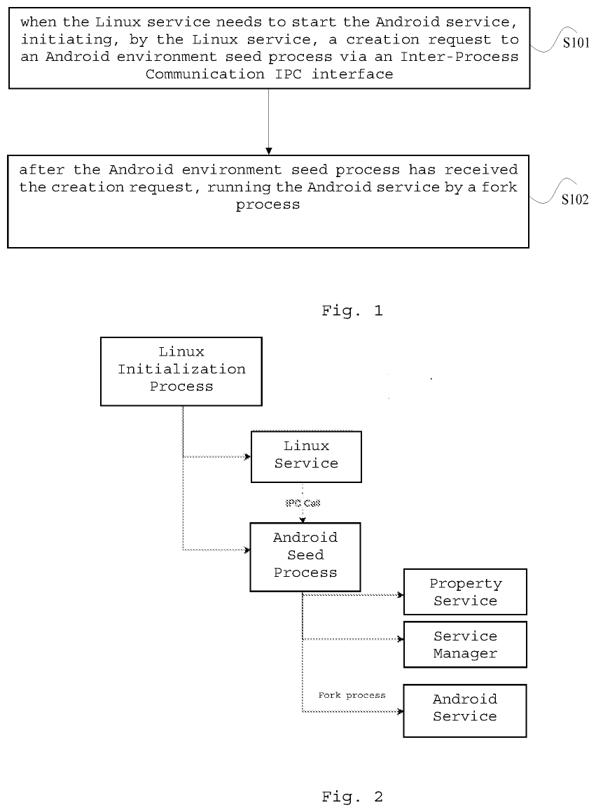

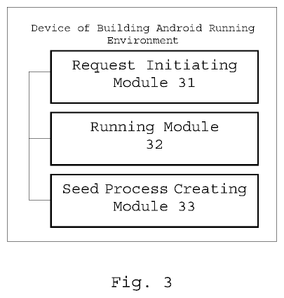

In some embodiments, the embodiments of the present application provides another flow chart of building an Android running environment. As shown in FIG. 2, a Linux initialization process is a Linux init process, a LinuxService is a Linux Service, and an Android seed process is the aforementioned Android environment seed process; the property service (PropertyService) and the service manager (ServiceManager) are management services, and both are basic services required for running the Android program; the AndroidService (Android Service) is an Android Service, for which the Linux Service requests to start the running. In some embodiments, when the Linux service needs to run the Android service, a request is sent to the Android seed process via the IPC interface, and after the Android seed process has received the request, the running of the Android service is created by means of a fork process.

It should be noted that the steps illustrated in the flow charts of the figures may be performed in a computer system such as a set of computer-executable instructions. Although a logical order is illustrated in the flow charts, in some cases, the steps illustrated or described may be performed in an order different than here.

According to some embodiments of the present application, there is further provided a device of building an Android running environment, which is used for implementing the above method in FIG. 1. As shown in FIG. 3, the device comprises: a request initiating module 31 for, when a Linux service needs to start an Android service, initiating, by the Linux service, a creation request to an Android environment seed process via an Inter-Process Communication IPC interface, the creation request at least comprising a path and a running parameter of a program corresponding to the Android service that needs to be started; a running module 32 for running, after the Android environment seed process received the creation request, the Android service by a fork process.

In some embodiments, the device further comprises: a seed process creating module 33 for creating the Android environment seed process on the Linux system according to the following steps of: separating a file system of the Android environment seed process from a Linux file system; mounting an Android file system required for running an Android program, and uninstalling a Linux file system which conflicts with the Android file system; creating a basic service process or thread required for running the Android program.

In some embodiments, the separating a file system of the Android environment seed process from a Linux file system comprises: separating the file system of the Android environment seed process from the Linux file system according to a file path.

In some embodiments, the mounting an Android file system required for running an Android program comprises: mounting the Android file system corresponding to the application scene according to an actual application scene.

In some embodiments, the creating a basic service process or thread required for running the Android program comprises: creating a new thread corresponding to the basic service or forking a new process.

In some embodiments, the seed process creating module 33 is further used for judging whether to switch a root directory of the Android file system or not according to different application scenes.

In some embodiments, the seed process creating module 33 is further used for: at least mounting a file system of a third-party class library extension directory vendor and a file system of a Vendor Native Development Kit (VNDK) required for running an Android hardware abstraction layer (Android HAL).

In some embodiments, the seed process creating module 33 is further used for: at least creating a property service and a service manager (ServiceManager) service.

In some embodiments, specific processes of implementing functions of various units and modules in the device in the embodiments of the present application may refer to related descriptions in the method embodiments, and are not described herein again.

In the device of building the Android running environment in the embodiments of the present application, a lightweight Android running environment is created on a Linux system, and in some embodiments, it is an Android environment seed process. When a Linux service needs to start an Android service, the Linux service initiates a creation request to an Android environment seed process via an IPC interface, and after the Android environment seed process received the creation request, the Android service is run by means of a fork process. Since the Android running environment of the Android environment speed process has been configured, the Android running environment can be completely inherited by means of fork. The present application is a copy inheritance mechanism of a parent-child process running environment based on a Linux system, and utilizes an environment seed process to derive fork so as to run the required Android service process. Compared with the mode of building an Android running environment with the aid of a LXC and other container tool in the related art, resources can be greatly saved and the starting speed of the Android service can be improved.

According to the embodiment of the present application, there is further provided a non-transitory computer-readable storage medium, characterized in that, the computer-readable storage medium stores computer instructions for causing the computer to perform the method of building an Android running environment in the foregoing method embodiment.

According to some embodiments of the present application, there is further provided an electronic apparatus, comprising: at least one processor; and a memory communicatively connected to the at least one processor; wherein the memory stores a computer program executable by the at least one processor, the computer program being executable by the at least one processor to cause the at least one processor to perform the method of building an Android running environment in the above method embodiments.

According to some embodiments of the present application, there is further provided a computer program comprising: instructions that, when executed by a processor, cause the processor to perform the method of building an Android running environment in any one of the above embodiments.

According to some embodiments of the present application, there is further provided a computer program product comprising instructions that, when executed by a processor, cause the processor to perform the method of building an Android running environment in any one of the above embodiments.

It should be obvious to those skilled in the art that the various modules or steps of the present application described above can be implemented by a general-purpose computing device, they can be centralized on a single computing device or distributed on a network composed of a plurality of computing devices. Alternatively, they may be implemented by program code executable by the computing device. Thus, they may be stored in a storage device and executed by the computing device, or they may be separately manufactured as respective integrated circuit modules, or a plurality of modules or steps therein may be manufactured as a single integrated circuit module for implementation. In this way, the present application is not limited to any specific combination of hardware and software.

The above description is only a preferred embodiment of the present application and is not intended to limit the present application, and various modifications and changes may be made to the present application by those skilled in the art. Any modification, equivalent replacement, or improvement made within the spirit and principle of the present application shall be comprised in the protection scope of the present application.

1. A method of building an Android running environment, comprising:
initiating a creation request to an Android environment seed process via an Inter-Process Communication (IPC) interface by a Linux service, when the Linux service needs to start an Android service, the creation request comprising a path and a running parameter of a program corresponding to the Android service that needs to be started; and
running, the Android service by a fork process, after the Android environment seed process received the creation request.

2. The method of building an Android running environment according to claim 1, further comprising creating the Android environment seed process on a Linux system according to following steps of:
separating a file system of the Android environment seed process from at least one Linux file system;
mounting an Android file system required for running an Android program;
uninstalling a Linux file system of the at least one Linux file system which conflicts with the Android file system; and
creating a basic service process or thread required for running the Android program.

3. The method of building an Android running environment according to claim 2, further comprising:
judging whether to switch a root directory of the Android file system or not according to different application scenes.

4. The method of building an Android running environment according to claim 2, wherein the mounting the Android file system required for running the Android program comprises:
mounting a file system of a third-party class library extension directory vendor and a file system of a Vendor Native Development Kit (VNDK) required for running an Android hardware abstraction layer (Android HAL).

5. The method of building an Android running environment according to claim 2, wherein, the creating the basic service process or thread required for running the Android program comprises:
creating a property service and a service manager (ServiceManager) service.

6. The method of building an Android running environment according to claim 2, wherein, the separating the file system of the Android environment seed process from the Linux file system comprises:
separating the file system of the Android environment seed process from the Linux file system according to a file path.

7. The method of building an Android running environment according to claim 2, wherein, the mounting the Android file system required for running the Android program comprises:
mounting the Android file system corresponding to an actual application scene.

8. The method of building an Android running environment according to claim 2, wherein, the creating the basic service process or thread required for running the Android program comprises:
creating a new thread corresponding to the basic service or forking a new process.

9-11. (canceled)

12. A non-transitory computer-readable storage medium, wherein, the computer-readable storage medium storing computer instructions for causing the computer to perform the method of building an Android running environment, comprising:
initiating a creation request to an Android environment seed process via an Inter-Process Communication (IPC) interface by a Linux service, when the Linux service needs to start an Android service, the creation request comprising a path and a running parameter of a program corresponding to the Android service that needs to be started; and
running, the Android service by a fork process, after the Android environment seed process has received the creation request.

13. An electronic apparatus, comprising: at least one processor; and a memory communicatively connected to the at least one processor; wherein the memory stores a computer program executable by the at least one processor, the computer program being executable by the at least one processor to cause the at least one processor to perform the method of building an Android running environment, comprising:
initiating a creation request to an Android environment seed process via an Inter-Process Communication (IPC) interface by a Linux service, when the Linux service needs to start an Android service, the creation request comprising a path and a running parameter of a program corresponding to the Android service that needs to be started; and
running, the Android service by a fork process, after the Android environment seed process has received the creation request.

14. (canceled)

15. (canceled)

16. The electronic apparatus according to claim 13, wherein the at least one processor performs a step of:
creating the Android environment seed process on a Linux system according to following steps of:
separating a file system of the Android environment seed process from at least one Linux file system;
mounting an Android file system required for running an Android program;
uninstalling a Linux file system of the at least one Linux file system which conflicts with the Android file system; and
creating a basic service process or thread required for running the Android program.

17. The electronic apparatus according to claim 16, wherein the at least one processor performs a step of:
judging whether to switch a root directory of the Android file system or not according to different application scenes.

18. The electronic apparatus according to claim 16, wherein the at least one processor performs a step of:
mounting a file system of a third-party class library extension directory vendor and a file system of a Vendor Native Development Kit (VNDK) required for running an Android hardware abstraction layer (Android HAL).

19. The electronic apparatus according to claim 16, wherein the at least one processor performs a step of:
creating a property service and a service manager (ServiceManager) service.

20. The electronic apparatus according to claim 16, wherein the at least one processor performs a step of:
separating the file system of the Android environment seed process from the Linux file system according to a file path.

21. The electronic apparatus according to claim 16, wherein the at least one processor performs a step of:
mounting the Android file system corresponding to an actual application scene.

22. The electronic apparatus according to claim 16, wherein the at least one processor performs a step of:
creating a new thread corresponding to the basic service or forking a new process.
